(19) United States
(12) Patent Application Publication
(10) Pub. No.: US 2012/0289290 A1
(43) Pub. Date: Nov. 15, 2012

(54) TRANSFERRING OBJECTS BETWEEN APPLICATION WINDOWS DISPLAYED ON MOBILE TERMINAL

(75) Inventors: Haeng-Suk CHAE, Gyeonggi-do (KR); Kyoung-Tae CHOI, Gyeonggi-do (KR)

(73) Assignee: KT CORPORATION, KT TECH INC.

(21) Appl. No.: 13/470,485

(22) Filed: May 14, 2012

(30) Foreign Application Priority Data
May 12, 2011 (KR) 10-2011-0044503
May 13, 2011 (KR) 10-2011-0045013
May 13, 2011 (KR) 10-2011-0045106

(51) Int. Cl. G06F 3/041; H04W 88/02; G09G 5/00

(52) U.S. Cl. 455/566; 345/672

(57) ABSTRACT

Provided are a mobile terminal and a method for transferring objects from a source application window to a destination application window, which are simultaneously displayed on a display unit of a mobile terminal. The method may include displaying the first application window and the second application window simultaneously on the display unit in response to a multi_screen mode initiation input, and transferring at least one of a portion of and an entire object in one of the first application window and the second application window to another application window in response to an object transferring mode initiation input.

### CROSS REFERENCE TO PRIOR APPLICATIONS

The present application claims priority under 35 U.S.C. §119 to Korean Patent Application No. 10-2011-0044503 (filed on May 12, 2011), Korean Patent Application No. 10-2011-0045013 (filed on May 13, 2011), and Korean Patent Application No. 10-2011-0045106 (filed on May 13, 2011), which are hereby incorporated by reference in their entireties.

### FIELD OF THE INVENTION

The present invention relates to transferring objects between applications and, in particular, to transferring contents among a plurality of applications running in a mobile terminal.

### BACKGROUND OF THE INVENTION

Various types of mobile terminals have been introduced. Most mobile terminals are equipped with a multi-touch sensing display unit. For example, a smart phone equipped with a multi-touch sensing display unit has become popular. The smart phone provides many convenient features to a user. A user may perform daily tasks using the smart phone instead of using other computing devices such as a computer, a fax, and a land-line phone.

Such a typical smart phone may display a graphic user interface to interact with a user and allow a user to perform multiple tasks simultaneously. Such a typical mobile terminal may, however, display one application window at a time although multiple applications are in operation as a background mode. For example, a typical mobile terminal may display only one application window associated with the one application that a user most recently activates among various user-initiated applications in operation. When a user wants to display another application window associated with another application running in a background mode, a user may be required to close a current application window and initiate another desired application to display an associated application window on a display unit. Such a manner of displaying application windows may be inconvenient to a user.

### SUMMARY OF THE INVENTION

This summary is provided to introduce a selection of concepts in a selection of concepts in a simplified from that are further described below in the detailed description with reference to the drawings. This summary is not intended to identify key features or essential features of the claimed subject matter, nor is it intended to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, objects may be transferred among applications running in a mobile terminal.

In accordance with another aspect of the present invention, objects may be transferred among application windows simultaneously displayed on a display unit of a mobile terminal.

In accordance with an embodiment of the present invention, a method may be provided for transferring objects from a first application window to a second application window displayed on a display unit of a mobile terminal. The method may include displaying the first application window and the second application window simultaneously on the display unit in response to a multi_screen mode initiation input, and transferring at least one of a portion of and an entire object in one of the first application window and the second application window to another application window in response to an object transferring mode initiation input.

The transferring at least one of a portion of and an entire object may include receiving an input from a user, determining whether the received input is the object transferring mode initiation input, performing an object transferring mode in response to the object transferring mode initiation input, otherwise, performing an operation associated with the received input.

The method may include determining that the received input is the object transferring mode initiation input when the received input is an input for selecting the at least one of the portion of and the entire object included in one of the first application window and the second application window.

The input for selecting the at least one of the portion of and the entire object may be at least one of a single tap input, a double tap input, a long press input, a tap and drag input, a drag and drop input, and a copy and paste input, which are made on the object included in the one of the first application window and the second application window.

The performing an object transferring mode may include determining a target object for transfer, determining a destination application window, and transferring the determined target object to the determined destination application window.

The method may include identifying the at least one of the portion of and the entire object selected by the object transferring mode initiation input as the target object and the one of the first application window and the second application window that includes the target object as the source application window.

The destination application window may be previously defined by at least one of a user, an application associated with the source application window, and an operating system of the mobile terminal.

When the object transferring mode initiation input is a copy and paste input, the method may include determining the target object associated with the copy and paste input, and determining the previously defined application window as the destination application window.

The determining a destination application window may include receiving an input after the determining a target object and determining the destination application window based on the received input.

The received input may be at least one of a single tap input, a double tap input, and a long press input, which are made on the destination application window, and a drag and drop input for dragging the selected object to the destination application window and dropping the selected object at the destination application window.

After the determining a target object, the performing an object transferring mode may include determining user editing of the determined target object, providing an editing tool associated with the target object for determined user editing, and updating the edited target object as the target object for transfer.

The transferring the at least one of the portion of and the entire object may include replicating the target object, displaying the replicated target object within the destination application window, and processing the replicated target object through the destination application window in response to input associated with the replicated target object.

The transferring the at least one of the portion of and the entire object may include storing the replicated target object in a clipboard.

The displaying the first application window and the second application window simultaneously on the display unit in response to a multi_screen mode initiation input may include displaying the first application window on an entire display area of the display unit, receiving the multi_screen mode initiation input from a user, dividing a display area of the display unit into at least two display areas including a first display area and a second display area in response to the multi_screen mode initiation input, and displaying the first application window and the second application window on the first display area and the second display area, respectively.

The receiving a multi_screen mode initiation input may include receiving an input from the user, determining whether the received input is at least one of a predetermined key button designated to initiate a multi_screen mode, a predetermined icon designated to initiate the multi_screen mode, a pinch input made by an associated pinching motion exceeding a shrinking threshold, and a spread input made by an associated spreading motion exceeding an expanding threshold, initiating the multi_screen mode when the received input is made through the at least one of the predetermined key button, the predetermined icon, the pinch input, and the spread input, and otherwise, performing an operation associated with the received input.

In accordance with another embodiment of the present invention, a mobile terminal may include a display unit, a touch input processor, and a controller. The display unit may be configured to sense a touch input made on a surface thereof, to determine coordinate values of the sensed touch input at a given interval, to display an application window on an entire display area in a single_screen mode, to display at least two application windows separately on divided display areas in a multi_screen mode, and to display objects being transferred from one application window to the other in an object transferring mode. The touch input processor may be configured to receive the coordinate value from the display unit and to determine whether the sensed touch input is at least one of a multi_screen mode initiation input, a single_screen mode initiation input, and an object transferring mode initiation input based on the received coordinate values of the touch input. The controller may be configured to initiate at least one of a multi_screen mode, a single_screen mode, and an object transferring mode based on the determination result of the touch input processor.

The touch input processor may determine, based on the received coordinate value, whether the sensed touch input is at least one of a single tap input, a double tap input, a long press input, a tap and drag input, a drag and drop input, and a copy and paste input, which initiate the object transferring mode. When the sensed touch input is the at least one of a single tap input, a double tap input, a long press input, a tap and drag input, a drag and drop input, and a copy and paste input, the touch input processor communicate to the controller of the initiation of the object transferring mode.

The touch input processor may determine whether the sensed touch input is at least one of a predetermined icon, a closing request, a pinch input, and a spread input based on the received coordinate values of the sensed touch input. In case of the predetermined icon, the touch input processor may determine that the sensed touch input is at least one of the multi_screen mode initiation input and the single_screen mode initiation input when the predetermined icon is associated with initiation of one of the multi_screen mode initiation input and the single_screen mode initiation input. When the sensed touch input is the closing request, the touch input processor may determine that the sensed touch input is the single_screen mode initiation input. In case of the pinch input, the touch input determine that the pinch input is at least one of the multi_screen mode initiation input and the single_screen mode initiation input when pinching motion of the pinch input exceeds a range of shrinking an application window. In case of the spread input, the touch input processor may determine that the spread input is at least one of the multi_screen mode initiation input and the single_screen mode initiation input when spreading motion of the spread input exceeds a range of expanding an application window.

When the touch input processor communicates the initiation of the object transferring mode, the controller may determine a target object based on the sensed touch input, determine a destination application window based on the sensed touch input, replicate the target object, control the display unit to display the replicated target object within the destination application window, and enable an application associated with the destination application window in response to input from a user.

When the touch input is the multi_screen mode initiation input based on the determination result of the touch input processor, the controller may divide a display area of the display unit into at least two display areas including a first display area and a second display area, activate a second application previously defined by one of a user and a manufacturer of the mobile terminal, reconfigure a first application window corresponding to the first display area, display the reconfigured first application window on the first display area, and display a second application window associated with the second application on the second display area, wherein the first application window is an application window previously displayed on an entire display area of the display unit.

When the touch input is the single_screen mode initiation input based on the determination result of the touch input processor, the controller may close one, associated with the single_screen mode initiation input, of the first application window and the second application window, and display the other one of the first application window and the second application window on the entire display area of the display unit.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows a mobile terminal operating in a multi_screen mode in accordance with an embodiment of the present invention;

FIG. 2 shows a display area of a display unit, divided into two display areas in accordance with an embodiment of the present invention;

FIG. 3 shows examples of initiating a multi_screen mode in response to various types of inputs in accordance with an embodiment of the present invention;

FIG. 4 shows a mobile terminal for transferring objects from a source application window to a destination application window simultaneously displayed on a display unit in accordance with an embodiment of the present invention;

FIG. 5 shows a mobile terminal in accordance with an exemplary embodiment of the present invention;

FIG. 6 shows a method for transferring objects from a source application window to a destination application window simultaneously displayed on a display unit of a mobile terminal in accordance with an embodiment of the present invention in accordance with an embodiment of the present invention;

FIG. 7 shows a mobile terminal performing an object transferring mode using a clipboard based on a drag and drop input in accordance with an embodiment of the present invention;

FIG. 8 shows a mobile terminal performing an object transferring mode in accordance with another exemplary embodiment of the present invention.

FIG. 9 shows a mobile terminal performing an object transferring operation in accordance another embodiment of the present invention;

FIG. 10 shows a method for transferring objects from a source application window to a destination application window in accordance with another exemplary embodiment of the present invention; and

FIG. 11 shows a mobile terminal for displaying one application window to be overlapped over the other in accordance with an exemplary embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

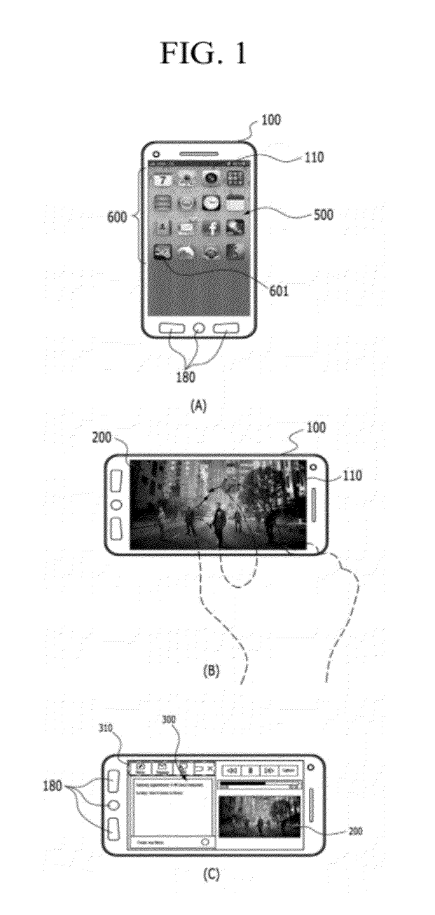

FIG. 1 shows a mobile terminal operating in a multi_screen mode in accordance with an embodiment of the present invention.

Referring to FIG. 1, mobile terminal 100 may include display unit 110 and key buttons 180 in accordance with an embodiment of the present invention. Mobile terminal 110 may be referred to as a mobile station (MS), user equipment (UE), a user terminal (UT), a wireless terminal, an access terminal (AT), a terminal, a subscriber unit (SU), a subscriber station (SS), a wireless device, a wireless communication device, a wireless transmit/receive unit (WTRU), a mobile node, and so forth. Furthermore, the mobile terminal may be referred to as a cellular phone, a smart phone, a personal digital assistant capable of radio communication, and a portable multimedia player (PMP), a portable computer equipped with a wireless MODEM or capable of wireless communication, an image capturing device capable of wireless communication, a gaming device capable of wireless communication, a music playback device capable of wireless communication, an Internet device capable of wireless internet access and browsing, and a television having a touch screen. The present invention, however, is not limited thereto. Display unit 110 may be a touch sensing display unit. Particularly, display unit 110 may be a multi_touch sensing display unit that is capable of recognizing multiple points of contact made on a surface of display unit 110. Mobile terminal 100 may simultaneously display at least two application windows on display unit 110 in a multi_screen mode as shown in a diagram (C) of FIG. 1. Such a multi_screen mode may be initiated in response to a certain input made by a related user in accordance with an embodiment of the present invention. The certain input may be referred to as a multi_screen mode initiation input. The multi_screen mode initiation input may be set up by a user, a service provider or a system designer. For example, one of key buttons 180 may be designated as a multi_screen mode initiation input. One of icons 600 displayed within initial graphic user interface 500 may be designated as multi_screen mode initiation input. The initial graphic user interface may be produced by an operating system, such as an android operating system, of mobile terminal 100. Particularly, a gesture input made on display unit 110 may be designated as the multi_screen mode initiation input. For example, a pinch input and/or a spread input may be designated as the multi_screen mode initiation input.

As shown in a diagram (A) of FIG. 1, mobile terminal 100 may display initial graphic user interface 500 on a display area of display unit 110 when mobile terminal 100 is activated. Initial graphic user interface 500 may be produced by an operating system of mobile terminal 100. For example, the operating system may be an android operating system, but the present invention is not limited thereto. Initial graphic user interface 500 may include a plurality of icons 600 associated with applications installed in mobile terminal 100. Applications may be downloaded from a related server or directly installed from an external device by a related user. Initial graphic user interface 500 may enable a related user to interact with desired applications. The related user may initiate desired applications by touching icons 600 associated with the desired applications. For example, the related user may activate a movie player application, as a first application, by making a touch input on corresponding icon 601. In this case, mobile terminal 100 may display first application window 200 associated with the first application on display unit 110, as shown in a diagram (B). As shown in the diagram (B), a movie is played back on display unit 110 as first application window 200.

The related user may activate a second application while the first application is running. In this case, mobile terminal 100 may transition the first application to a background mode and perform the second application as a foreground mode. That is, mobile terminal 100 may close first application window 200 associated with the first application and display another application window associated with the second application. Typically, mobile terminal 100 may display one application window at a time although multiple applications are in operation. For example, a typical mobile terminal may display only one application window associated with one that a user most recently activates among applications in operation. When a user wants to display another application window associated with another application running in a background mode, a user may be required to close a current application window and initiate another desired application to display an associated application window on a display unit. The typical android operation system for a mobile terminal generally does not display two or more application windows on a display unit simultaneously. Such a manner of displaying application windows may be inconvenient to a user.

In order to overcome such drawback of a typical mobile terminal, mobile terminal 100 in accordance with an embodiment of the present invention may display at least two application windows simultaneously as shown in a diagram (C) of FIG. 1. Such a multi_screen mode of mobile terminal 100 may be initiated through a certain input, a multi_screen mode initiation input, made by a user. In a diagram (B) of FIG. 1, the multi_screen mode initiation input may be illustrated as a pinch input, but the present invention is not limited thereto. Such multi_screen mode initiation input may be a keypad input, a key button input, or another gesture input, set by a user, a service provider, or a system designer.

Referring to a diagram (B) of FIG. 1, when a user makes a pinch input on first application window 200, mobile terminal 100 may determine that the pinch input is a multi_screen mode initiation input when the pinch input exceeds a shrinking threshold, and activate a multi_screen mode in accordance with an embodiment of the present invention. For example, mobile terminal 100 may divide a display area of display unit 110 into two display areas. Mobile terminal 100 may shrink first application window 200 and display the reduced-size first application window 200 on a right half display area of display unit 110 and display second application window 300 on a left half display area of display unit 110 as shown in a diagram (C) of FIG. 1. In a diagram (C) of FIG. 1, reduced-size first application window 200 may be illustrated as being displayed on the right display area of display unit 110 and second application window 300 may be illustrated as being displayed on the left display area of display unit 110. The present invention, however, is not limited thereto. Reduced-size first application window 200 may be displayed on a left half display area of display unit 110 and second application window 300 may be displayed on a right half display area of display unit 110. Furthermore, more than three application windows may be displayed in accordance with another exemplary embodiment of the present invention.

In accordance with an exemplary embodiment of the present invention, second application window 300 may be associated with an application that enables a user to select one of three applications. For example, second application window 300 may be associated with a multitasking application. Such an application may be selected and set up by a system designer in advance. As shown in a diagram (C) of FIG. 1, second application window 300 may include taps 301 for selecting one of three applications, for example, a memo application, a message application, and a social network service (SNS) application. The present invention, however, is not limited thereto. Second application window 300 may be associated with any applications installed in mobile terminal 100. A user may select and set up one of the applications to be activated and to display an associated application window on one of display areas of display unit 110 when the multi_screen mode is initiated. For example, when the multi_screen mode initiation input is made while a movie is played back as a first application window, mobile terminal 100 may display an application window associated with an application that enables a user to select one of applications installed in mobile terminal 100 or display an initial graphic user interface on one of divided display areas in display unit 110.

Such a multi_screen mode may be returned back to a single_screen mode in response to a certain input made by a related user in accordance with an embodiment of the present invention. The certain input may be referred to as a single_screen mode initiation input. The single_screen mode initiation input may be set up by a user, a service provider, or a system designer. For example, one of key buttons 180 may be designated as a single_screen mode initiation input. One of icons 600 displayed within an initial graphic user interface may be designated as the single_screen mode initiation input. Particularly, a gesture input made on display unit 110 may be designated as the single_screen mode initiation input. For example, a pinch input and/or a spread input may be designated as the single_screen mode initiation input. In response to the single_screen mode initiation input, one of first and second application windows 200 and 300 may be closed and the other may be displayed on entire display area of device unit 110 in accordance with an embodiment of the present invention.

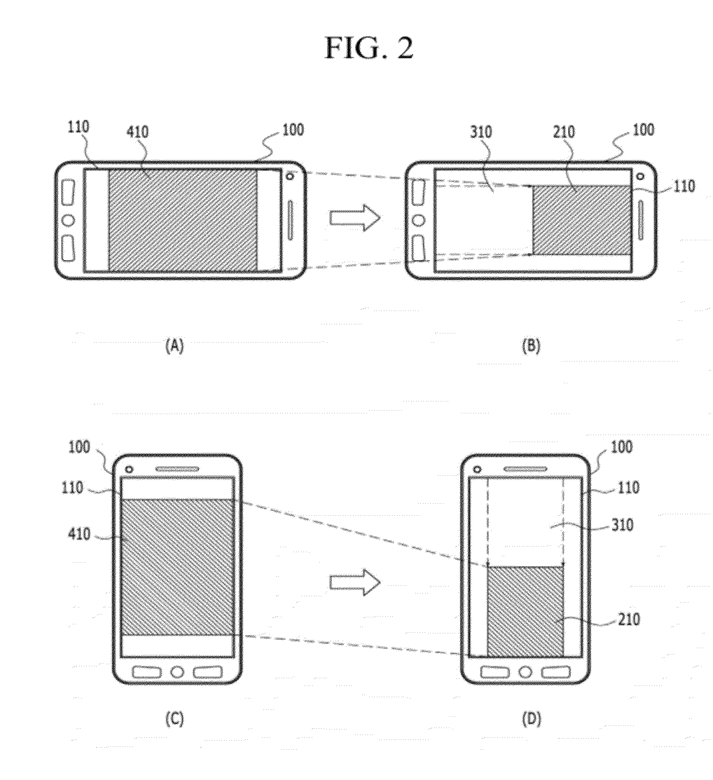

FIG. 2 shows a display area of a display unit, divided into two display areas in accordance with an embodiment of the present invention.

Referring to diagrams (A) and (B) of FIG. 2, display area 410 of display unit 110 may be divided into first display area 210 and second display area 310 in response to a multi_screen mode initiation input in accordance with an embodiment of the present invention. First display area 210 may be referred to as a main display area and second display area 310 may be referred to as a multitasking display area, but the present invention is not limited thereto. For example, first application window 200 displayed on entire display area 410 of display unit 110 may be reduced in size in response to a multi_screen mode initiation input and reduced-size first application window 200 may be displayed on first display area 210. Then, second application window 300 may be displayed on second display area 310.

Diagrams (A) and (B) of FIG. 2 illustrate display area 410 vertically divided into first display area 210 and second display area 310. The present invention, however, is not limited thereto. Display area 410 may be horizontally divided into lower display area 210 and upper display area 310 as shown in diagrams (C) and (D) of FIG. 2.

Furthermore, display area 410 may be illustrated as being divided in a ratio of 1:1 in FIG. 2, but the present invention is not limited thereto. That is, first display area 210 and second display area 310 may have the same size, such as illustrated in FIG. 2. However, display area 410 may be divided in a ratio of x:y, for example, 2:1, 1:2, 3:1, or 1:3, in accordance with another exemplary embodiment of the present invention. That is, first display area 210 and second display area 310 may have different sizes in accordance with another exemplary embodiment of the present invention.

As described above, a multi_screen mode and a single_screen mode may be initiated in response to a multi_screen mode initiation input and a single_screen mode initiation input in accordance with an embodiment of the present invention. The multi_screen mode initiation input and the single_screen mode initiation input may be set up by a user, a service provider, or a system designer. For example, one of key buttons 180 may be designated as a multi_screen mode initiation input and a single_screen mode initiation input. One of icons displayed within an initial graphic user interface may be designated as multi_screen mode initiation input and a single_screen mode initiation input. Particularly, a gesture input made on display unit 110 may be designated as the multi_screen mode initiation input and a single_screen mode initiation input. For example, a pinch input and/or a spread input may be designated as the multi_screen mode initiation input and the single_screen mode initiation input when corresponding gestures exceed given thresholds.

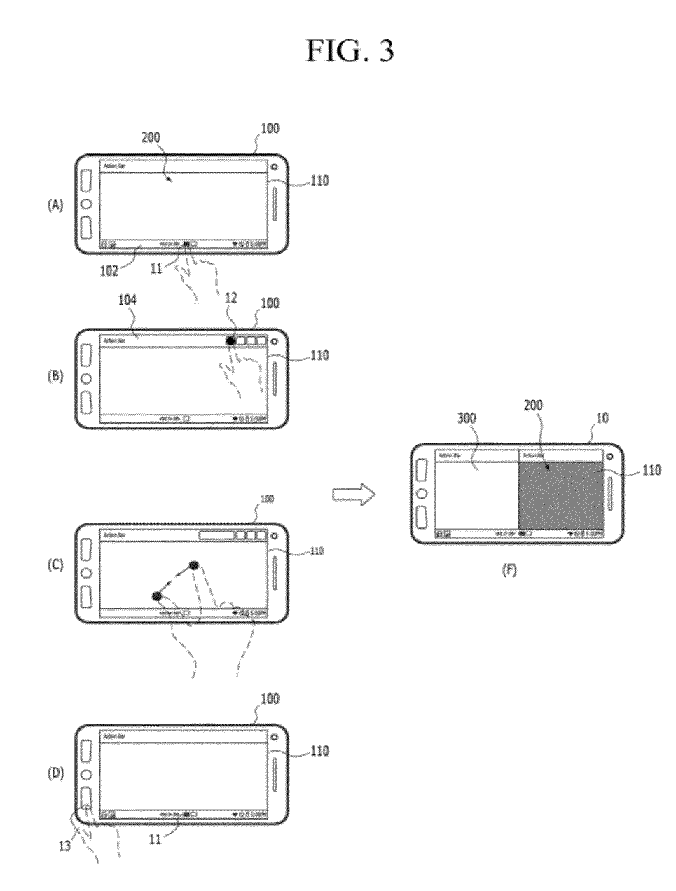

FIG. 3 shows examples of initiating a multi_screen mode in response to various types of inputs in accordance with an embodiment of the present invention.

As shown in a diagram (A) of FIG. 3, menu button 11 displayed with first application window 200 may be designated as multi_screen mode initiation input. Menu button 11 may be disposed in lower menu bar 102 of first application window 200. In this case, when a user makes a touch input on menu button 11, the multi_screen mode may be initiated and first and second application windows 200 and 300 may be simultaneously displayed on display unit 110 as shown in a diagram (F) of FIG. 3.

As shown in a diagram (B) of FIG. 3, another menu button 12 on upper bar 104 displayed with first application window 200 may be designated as multi_screen mode initiation input. Unlike menu button 11, menu button 12 may be disposed on upper menu bar 104 of first application window 200. In this case, when a user makes a touch input on menu button 12, the multi_screen mode may be initiated and first and second application windows 200 and 300 may be simultaneously displayed on display unit 110 as shown in a diagram (F) of FIG. 3.

As shown in a diagram (C) of FIG. 3, a gesture input made on display unit 110 may be designated as the multi_screen mode initiation input. In this case, when a user makes such gesture input, the multi_screen mode may be initiated and first and second application windows 200 and 300 may be simultaneously displayed on display unit 110 as shown in a diagram (F) of FIG. 3. For example, a pinch input and/or a spread input may be designated as the multi_screen mode initiation input when corresponding gestures exceed given thresholds.

As shown in a diagram (D) of FIG. 3, key button 13 disposed on mobile terminal 100 may be designated as a key button for the multi_screen mode in initiation input. When mobile terminal 100 receives an input through key button 13, the multi_screen mode may be initiated and first and second application windows 200 and 300 may be simultaneously displayed on display unit 110 as shown in a diagram (F) of FIG. 3.

After simultaneously displaying at least two application windows as described above, mobile terminal 100 may transfer objects from a first application window to a second application window in response to an input made on display unit 110 by a user in accordance with exemplary embodiments of the present invention. The first application window may be produced by a first application and referred to as a source application window. The second application window may be produced by a second application and referred to as a destination application window. Transferring objects from the first application window and the second application window may mean replicating objects displayed within the first application window and being processed by the first application, transferring the replicas to the second application, displaying the replicas in the second application window, and enabling the second application to process the replicas through the second application window.

As described above, mobile terminal 100 in accordance with an embodiment of the present invention may simultaneously display the first and second application windows on display unit 110. Mobile terminal 100 may select at least one of various objects displayed within the first application window in response to a certain input from a user, replicate the selected object, transfer a replica of the selected object to the second application in response to a certain input from a user, display the replica within the second application window, and enable the second application within the second application window in response to another input from the user. Such an operation of mobile terminal 100 may be referred as an object transferring mode, hereinafter. The object transferring mode of mobile terminal 100 may be initiated by one input or a group of consecutive inputs made on a graphic user interface of mobile terminal 100 by a user. Such input may be gesture inputs. For example, a single tap input, a double tap input, a long press input, a tap and drag input, a drag and drop input, and a copy and paste input may be determined as an input for initiating the object transferring mode. Such inputs may be referred to as the object transferring mode initiation input. The present invention, however, is not limited thereto. Any input and groups of inputs may be defined by a user, a service provider, or a manufacturer of mobile terminal 100 as the object transferring mode initiation input.

In accordance with an exemplary embodiment of the present invention, the first and second applications may perform different features from each other. For example, the first application may be a web browser application that receives information from a related server through a network and produce and display a web-browser with the received information on an assigned display area of a display unit. The second application may be an editor application that edits data in response to inputs from a user and produce and display an editing window on other assigned display area of the display unit. In the object transferring mode, mobile terminal 100 may select an object such as a text or an image displayed within the web-browser in response to an input from a user, transfer the selected object to the editing window, and enable the editor application to edit the transferred object in response to an input from the user. Such an object transferring mode may be initiated and performed in response to a drag and drop input, but the present invention is not limited thereto.

For another example, the first application may be a contact application that stores a list of contacts, and might produce and display a contact window on an assigned display area of the display unit. The second application may be an e-mail application that enables a user to read and write an e-mail and produce and display an e-mail window on other assigned display area of the display unit. In the object transferring mode, mobile terminal 100 may select an e-mail address displayed within the web-browser in response to an input from a user, transfer the selected e-mail address to a certain block of the e-mail window, and enable the e-mail application to use the transferred e-mail address as a destination address in response to an input from the user. Such an object transferring mode may be performed through a copy and paste input, but the present invention is not limited thereto.

Since mobile terminal 100 simultaneously displays at least two application windows, a user may conveniently transfer desired objects from one application window to the other in accordance with an embodiment of the present invention. Furthermore, mobile terminal 100 may visually display a process of transferring an object from one application window to the other in response to an input. In case of using a long press input and a drag and drop input for the object transferring mode, a user may select an object included in a first application window by making a long press input on a desired object. Then, mobile terminal 100 may highlight the selected object or make the selected object pop-up corresponding to the long press input of the user. The user may make a drag and drop input continuously after the long press input. That is, the user may drag the selected object from the first application window to a predetermined block of the second application window. The predetermined block may be a virtual storage space such as a clipboard. Mobile terminal 100 may visually display dragging the selected object from the first application window to the predetermined block of the second application window. At the moment the dragged object reaches the predetermined block, mobile terminal 100 may display the predetermined block to be expanded corresponding to the size of the dragged object. Then, the user may drop the dragged object into the predetermined block such as a clipboard. Mobile terminal 100 may temporarily store the predetermined block in the clipboard and transfer the stored object to the second application window. After transferring, mobile terminal 100 may display the predetermined block to be re-sized. Mobile terminal 100 may display the transferred object with the second application window. As described above, the user easily and conveniently confirms an entire process of transferring objects from one application window to the other. In accordance with exemplary embodiments of the present invention, the process of the object transferring mode may be displayed with various visual effects. Such visual effects may help a user to easily and conveniently recognize that inputs are being processed. Such visual effects may be popping-up a selected object, highlighting a selected object, expanding a block associated with inputs, overlapping an active application window over an inactive application window, displaying an active application window with higher brightness than an inactive application window, and displaying an inactive application window with lower brightness than an active application window. Such visual effects may be applied to the object transferring mode in various manners in exemplary embodiments of the present invention.

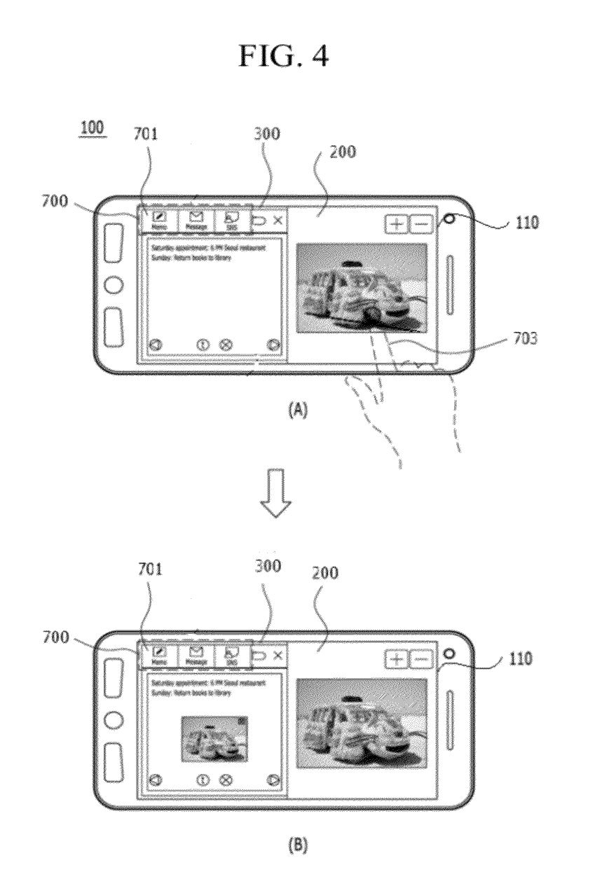

As described above, mobile terminal 100 may perform the object transferring mode in various ways. Hereinafter, one example of the object transferring mode in accordance with an exemplary embodiment of the present invention will be described with reference to FIG. 4.

FIG. 4 shows a mobile terminal for transferring objects from a source application window to a destination application window simultaneously displayed on a display unit in accordance with an embodiment of the present invention.

Referring to FIG. 4, mobile terminal 100 may display first application window 200 on a right half display unit and second application 300 on a left half display unit in display unit 110. The right half display unit may be referred to as a main display area and the left half display unit may be referred to as a multitasking area. For example, the main display area may continuously display first application window 200 that was displayed on entire display area of display unit 110 in single_screen mode. The multitasking display area may display second application window 300 that enables a user to perform multiple features provided in second application window 300. The present invention, however, is not limited thereto. For example, first application window 200 may be displayed on the left half display area as the main display area and second application window 300 may be displayed on the right half display area as the multitasking display area. Furthermore, first application window 200 may be displayed on an upper half display area as the main display area and second application window 300 may be displayed on a lower half display area.

Second application window 300 displayed on the multitasking display area may include top menu bar 700. Top menu bar 700 may include menu buttons each indicating applications that the user can activate. For example, top menu bar 700 may include menu buttons for activating a memo application, a message application, and a social networking service (SNS) application, and a web-browser application. When a user activates menu button 701 for the memo application, a memo window may be displayed on the multitasking display area as second application window 300 as shown in a diagram (A) of FIG. 4.

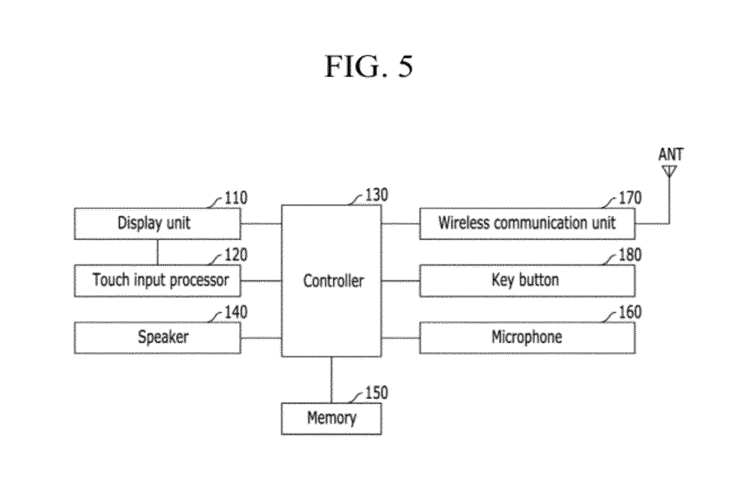

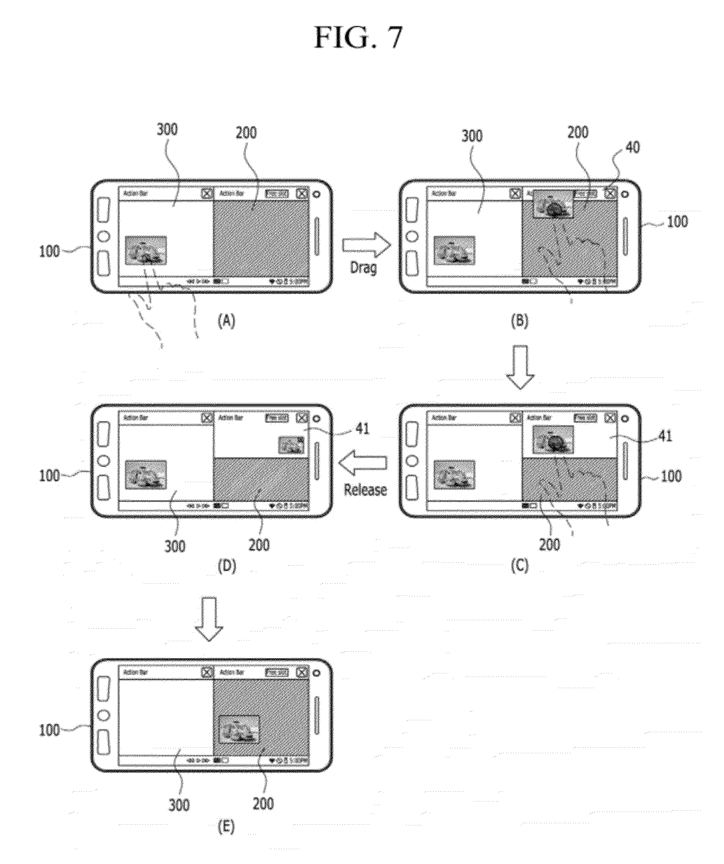

The main display area may display first application window 200. First application window 200 may be an image viewer application. While first and second application windows 200 and 300 are displayed on the main display area and the multitasking display area, a user may select objects in first application window 200 displayed on the main display area by making long press input 703 as shown in a diagram (A) of FIG. 4. Long press input 703 may be an input made on a surface of display unit 110 by making and press a contact on the surface for a certain time. In response to the long press input 703, the object transferring mode may be initiated in accordance with an embodiment of the present invention. Then, the selected object may be transferred from first application window 200 to second application window 300. Second application window 300 may be displayed with the transferred object as shown in a diagram (B) of FIG. 4. The selected object is described as being automatically transferred to second application window 300 by the long press input without selecting a destination application window, but the present invention is not limited thereto. For example, after selecting the object, the destination application window may be selected by making another input such as a drag and drop input. Such operation will be described subsequently with reference to FIG. 7. Hereinafter, mobile terminal 100 for transferring objects from a source application window to a destination application window in accordance with an exemplary embodiment of the present invention will be described with reference to FIG. 5.

FIG. 5 shows a mobile terminal in accordance with an exemplary embodiment of the present invention.

Referring to FIG. 5, mobile terminal 100 may include display unit 110, touch input processor 120, controller 130, speaker 140, memory 150, microphone 160, wireless communication unit 170, and key button 180. As described above, mobile terminal 100 may be a portable terminal, a mobile communication terminal, a smart phone, a personal digital assistant (PDA), and a portable multimedia player (PMP). Furthermore, mobile terminal 100 may be operated by an android operating system, but the present invention is not limited thereto.

Display unit 110 may be a touch sensing display unit. Particularly, display unit 110 may be a multi_touch sensing display unit that is capable of recognizing multiple points of contact made on a surface of display unit 110. Accordingly, display unit 110 may sense a touch input made by a user and provide the sensed touch input to touch input processor 120 in accordance with an exemplary embodiment of the present invention. For example, display unit 110 may sense a touch input made in a shape of a rectangle, a circle, and a line, detect a coordinate value (x, y) of the touch input at a regular interval such as about 20 ms, and provide the detected coordinate values (x, y) to touch input processor 120.

That is, display unit 110 may be an input unit for receiving a touch input as well as a display unit for displaying a graphic user interface including an application window. In accordance with an exemplary embodiment of the present invention, display unit 110 may receive a multi_screen mode initiation input and a single_screen mode initiation input as well as other touch inputs made for initiating a certain feature of mobile terminal 100. Furthermore, display unit 110 may receive an object transferring mode initiation input in accordance with an embodiment of the present invention. The touch input may include a tap input, a double tap input, a long press input, a scroll input, a pan input, a flick input, a two finger tap input, a two finger scroll input, a pinch input, a two hand pinch input, a spread input, a two hand spread input, a rotate input, and a two hand rotate input. Among the touch inputs, the pinch input and the spread input may be determined as the multi_screen mode initiation input and the single_screen mode initiation input when the pinch input and the spread input exceed given thresholds in accordance with an embodiment of the present invention. The present invention, however, is not limited thereto. Other touch inputs may be selected and set up as the multi_screen mode initiation input and the single_screen mode initiation input with certain conditions. Furthermore, the touch input may include a tap and drag input, a drag and drop input, and a copy and paste input. Among the touch inputs, a single tap input, a double tap input, a long press input, a tap and drag input, a drag and drop input, and a copy and paste input may be determined as an input for initiating the object transferring mode. That is, objects may be selected and transferred in response to at least one of the single tap input, the double tap input, the long press input, the tap and drag input, the drag and drop input, and the copy and paste input in accordance with an exemplary embodiment of the present invention. The present invention, however, is not limited thereto. Other touch inputs may be selected and defined as the object transferring mode initiation input.

Display unit 110 may employ one of a capacitive overlay type touch screen, a resistive overlay type touch screen, an infrared beam type touch screen, and a surface acoustic wave type touch screen, but the present invention is not limited thereto. Display unit 110 may employ other types of touch screens to detect touch inputs made thereon by a user. Display unit 110 may detect values corresponding to touch inputs made thereon. Such values may be a potential difference value, a capacitance value, a wavelength, or an infrared ray (IR) interrupt value.

For example, in case of a resistive overlay type touch screen, display unit 110 may detect a potential difference on a position where a touch input is made. Display unit 110 may determine a coordinate value (x, y) of the position based on the detected potential difference and provide the coordinate value (x, y) to touch input processor 120.

Display unit 110 may display graphic user interfaces and application windows in response to control of controller 130. For example, display unit 110 may display initial graphic user interface 500 when mobile terminal 100 is initiated. Such initial graphic user interface 500 may be produced by an operating system of mobile terminal 100. Display unit 110 may display application windows associated with applications installed in mobile terminal 100. A user activates one of icons 600 (FIG. 1) associated with applications and in initial graphic user interface 500. Display unit 110 may display an application window associated with the activated application.

In accordance with an exemplary embodiment of the present invention, display unit 110 may simultaneously display at least two application windows on two divided display areas in a multi_screen mode. Further, display unit 110 may display only one application window on entire display area in a single_screen mode.

In accordance with an exemplary embodiment of the present invention, display unit 110 may display an entire process of transferring an object from one application window to the other in response to inputs from a user. Accordingly, the user may be enabled to visually confirm the object transferring process performing in response to the input made by the user.

Touch input processor 120 may receive coordinate values (x, y) associated with a touch input made on display unit 110 at a regular interval and determine a type of the touch input. For example, touch input processor 120 may determine whether a touch input is to activate an icon or a menu button designated to initiate one of the multi_screen mode initiation input and the single_screen mode initiation input. Such a menu button may be menu buttons 11 and 12 shown in FIG. 3. Furthermore, touch input processor 120 may compare two consecutive coordinate values and detect an increment and/or a decrement of the coordinate values based on the comparison results. Touch input processor 120 may determine whether the touch input is a pinch input or a spread input based on the detected increment and decrement.

Touch input processor 120 may also determine whether a touch input is to initiate the object transferring mode based on the received coordinate values (x,y). Such a touch input may be made using one finger or two fingers. Such an object transferring mode initiation input may be a single tap input, a double tap input, a long press input, a tap and drag input, a drag and drop input, or a copy and paste input. When touch input processor 120 determines that the received touch input is the object transferring mode initiation input, touch input processor 120 may transfer the determination result to controller 130. Furthermore, touch input processor 120 may determine whether the received touch input is to select a part of an object or an entire object, displayed with a corresponding application window and transmit the determination result to controller 130.

Touch input processor 120 may determine whether the received touch input is intended i) to close or ii) to end (or terminate) one of application windows simultaneously displayed on display unit 110. Touch input processor 120 may transmit the determination result to controller 130.

Controller 130 may control constituent elements of mobile terminal 100 in overall. In accordance with an exemplary embodiment of the present invention, controller 130 may control display unit 110 to be operated in the multi_screen mode or in the single_screen mode in response to certain touch inputs determined by touch input processor 120.

For example, when touch input processor 120 detects the multi_screen mode initiation input, controller 130 may divide display area 410 of display unit 110 into first display area 210 and second display area 310, display first application window 200 on first display area 210, and display second application window 300 on second display area 310. In case of the single_screen mode initiation input, controller 130 may close one of first and second display applications 200 and 300 and display the other on entire display area 410 of display unit 110.

In addition, controller 130 may detect the multi_screen mode initiation input and the single_screen mode initiation input received through one of key buttons 180. Such key button 180 may generate a signal when a user activates the one of key buttons 180. In response to the signal, controller 130 may determine that the multi_screen mode or the single_screen mode is initiated. In this case, controller 130 may control display unit 110 to display application windows in the multi_screen mode or the single_screen mode without the determination of touch input processor 120.

In accordance with an exemplary embodiment of the present invention, controller 130 may transfer an object from a source application window and a destination application window based on the determination result of touch input processor 120. For example, when touch input processor 120 determines that the received input is a drag and drop input, controller 130 may perform the object transferring mode in response to the drag and drop input.

For example, when touch input processor 120 determines that the received input is a long press input, controller 130 may create a virtual storage space, replicate the selected object, and temporally store the replica in the virtual storage space. The virtual storage space may be a clipboard. Furthermore, controller 130 may control display unit 110 to display a clipboard block at a certain position of a related application window. When touch input processor 120 determines that the following input is a drag and drop input, controller 130 may transfer the stored object to a destination application window indicated by the drag and drop input. Controller 130 may transfer not only the selected object but also information related thereto.

When touch input processor 120 determines that the received input is to select a part of object in a source application window, controller 130 may transfer the selected part of object from the source application window to a destination application window. Such an input for selecting a part of object may be a long press input or a two finger tap input. An input of transferring the selected part of object from the source application window to the destination application window may be a drag and drop input.

In addition, controller 130 may close or terminate one of first and second application windows simultaneously displayed on display unit 110 when touch input processor 120 determines that the received input is to close or to terminate one of the first and second application windows. For example, when touch input processor 120 determines that the received input is to close or to terminate the first application window, controller 130 may close the first application window and display the second application window on an entire display area of display unit 110. Such an input may be a single_screen mode initiation input.

Furthermore, controller 130 may enable a user to control only objects included in an activated one of the first and second application windows. When the first application window is activated and the second application window is inactivated, controller 130 may allow a user to control only objects included in the first application window.

Controller 130 may be illustrated as an independent unit from touch input processor 120 in FIG. 4. The present invention, however, is not limited thereto. Touch input processor 120 may be realized in controller 130 in accordance with another exemplary embodiment of the present invention.

Speaker 140 may receive an electric signal from controller 130, convert the electric signal to sound, and output the sound. Memory 150 may store information necessary for operating mobile terminal 100 and performing certain operations requested by a user. Such information may include any software programs and related data. For example, memory 150 may store an operating system, the operating system data, applications, and related data, received from an external device through a physical cable and downloaded from a related server from through a communication link. Memory 150 be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. Microphone 160 may convert sound of a user or around a user to an electric signal and output the electric signal to controller 130.

Wireless communication unit 170 may include at least one module for communicating with another party through a wireless communication system. For example, wireless communication unit 170 may include any or all of a duplexer, a radio frequency processor, and an intermediate processor. Wireless communication unit 170 may receive a radio frequency signal through an antenna ANT and the duplexer, convert the received radio frequency signal into an intermediate frequency signal, convert the intermediate frequency signal to a baseband signal again, and transmit the baseband signal to controller 130. Furthermore, wireless communication unit 170 may receive a baseband signal from controller 130, convert the baseband signal to an intermediate frequency signal and again to a radio frequency signal, and transmit the radio frequency signal through the antenna ANT.

Beside the constituent elements shown in FIG. 4, mobile terminal 100 may include other elements as well. For example, mobile terminal 100 may include a key input receiver (not shown) configured to receive various key inputs made through a key pad. The key input receiver may convert the key inputs to corresponding key codes and transmit the key codes to control 130. Control 130 may perform operations associated with the received key codes. Furthermore, mobile terminal 100 may include a camera module (not shown) including a complementary metal-oxide-semiconductor (CMOS) image sensor or a charge-coupled device (CCD) image sensor. The camera module may capture an image and process the captured image into a data format that can be displayed on display unit 110.

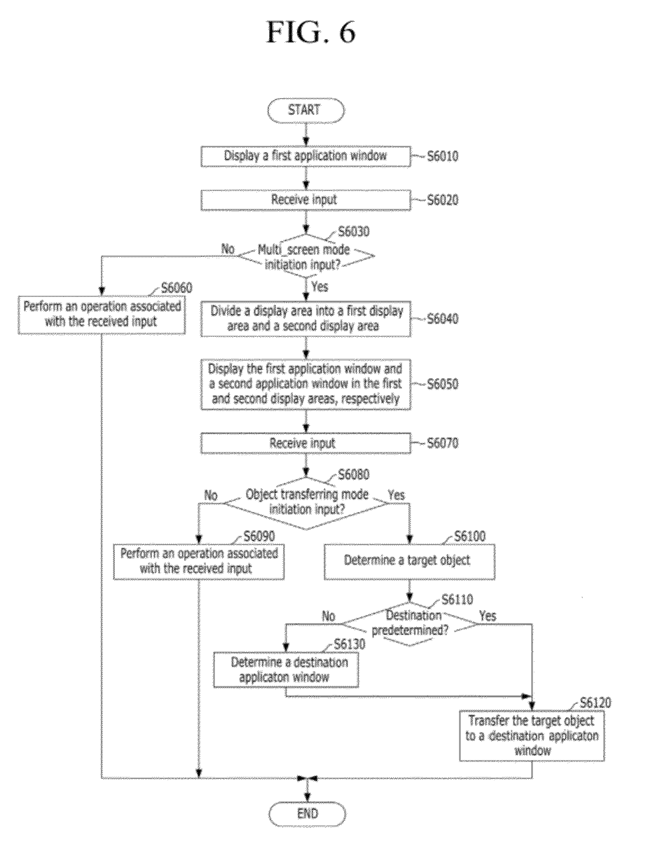

Hereinafter, a method for transferring objects from a source application window to a destination application window simultaneously displayed on a display unit of a mobile terminal in accordance with an embodiment of the present invention will be described with reference to FIG. 6.

FIG. 6 shows a method for transferring objects from a source application window to a destination application window simultaneously displayed on a display unit of a mobile terminal in accordance with an embodiment of the present invention in accordance with an embodiment of the present invention.

Referring to FIG. 6, when a user activates an application in a mobile terminal, a first application window associated with the activated application may be displayed on an entire display area of mobile terminal at step S6010. For example, mobile terminal 100 may display initial graphic user interface 500 when mobile terminal 100 is initiated. A user may activate icon 601 in initial graphic user interface 500 and mobile terminal 100 may display first application window 200 associated with icon 601 on entire display area 410. That is, mobile terminal 100 may display first application window 200 in a single_screen mode.

While displaying the first application window, an input may be received from a user at step S6020. For example, a related user may enter various types of inputs into mobile terminal 100 though at least one of graphic user interface 500, key buttons 180, and a key pad of mobile terminal 100 in order to perform a desired feature. Particularly, the related user may enter an input to display second application window 300 associated with an application running as a background mode. In this case, the user may activate a multi_screen mode in order to display second application window 300 with first application window 200 at the same time on display unit 110 of mobile terminal 100. When the user wants to initiate the multi_screen mode, the user may enter a multi_screen mode initiation input. The multi_screen mode initiation input may be one of menu buttons 11 and 12 displayed as a part of application window as shown in FIG. 3. The multi_screen mode initiation input may be one of icons 600 included in initial graphic user interface 500 displayed on display unit 110 of mobile terminal 100. Furthermore, the multi_screen mode initiation input may be one of keys in a keypad and key buttons, which is set up as the multi_screen mode initiation input by the user or a system designer. Particularly, the multi_screen mode initiation input may be a gesture input such as a pinch input and a spread input. As described above, various types of inputs may be received from the user.

At step S6030, determination may be made whether the received input is for initiating a multi_screen mode. As described above, when mobile terminal 110 receives an input, mobile terminal 110 may determine whether the received input is a multi_screen mode initiation input. When the received input is not the multi_screen mode initiation input (No—S6030), the process performs an operation associated with the received input at step S6060, and the process then terminates.

When the received input is the multi_screen mode initiation input (Yes—S6030), a display area may be divided into a first display area and a second display area at step S6040. For example, when mobile terminal 100 receives an input from menu button 11 in bottom menu bar 102, menu button 12 in top menu bar 104, key button 13 provided on mobile terminal 100, or gesture input such as a pinch input or a spread input, mobile terminal 100 may determine that the received input is the multi_screen mode initiation input. When mobile terminal 100 determines that the received input is the multi_screen mode initiation input, mobile terminal 100 may divide display area 410 into first display area 210 and second display area 310. The present invention, however, is not limited thereto. The display area may be divided into more than two display areas in accordance with another embodiment of the present invention. For convenience and ease of understanding, the display area will be described as being divided into two display areas, such as the first display area and the second display area.

At step S6050, the first application window may be displayed in the first display area and a second window may be displayed in the second display area. For example, mobile terminal 100 may reconfigure first application window 200, which was previously displayed on entire display area 410 of display unit 110, and display reconfigured first application window 200 in first display area 210. Since the entire display area is divided into two display areas, first application window 200 may be reduced in size to fit into first display area 210. Furthermore, mobile terminal 100 may activate a second application previously selected by one of a user, a service provider, and a manufacturer of mobile terminal 100. Mobile terminal 100 may display second application window 300 in second display area 310. Second application window 300 may be associated with the activated second application. The second application may be a multitasking application previously selected by a manufacturer of mobile terminal 100. The multitasking application may enable a user to choose and to perform one from a set of selected applications. Furthermore, the second application may be one of applications running in a background mode. Such background mode applications may be indicated on menu bars 102 and 104. A user may select and activate one of background applications indicated on menu bars 102 and 104. In response to the selection and activation, second application window 300 associated with the selected background application may be displayed on second display area 310. In addition second application window 300 displayed on second display area 310 may be changed by selecting another background application indicated in menu bars 102 and 104. For example, when a user may select one of applications indicated by menu bars 102 and 104 while second application window 300 is displayed on second display area 310, second application window 300 may be closed and an application window associated with the selected application may be displayed on second display area 310 as new second application window 300. The present invention, however, is not limited thereto. The second application may be any applications selected by a user or by mobile terminal 100 and a corresponding application window may be displayed on second display area 310. Instead of the applications, initial graphic user interface 500 may be displayed in the second display area as second application window 300.

At step S6070, an input may be received after the first and second application windows are displayed in the multi_screen mode. For example, various types of inputs may be received while first and second application windows 200 and 300 are displayed in the multi_screen mode. Such inputs may be for activating features included in first and second application windows.

At step S6080, determination may be made whether the received input is an object transferring mode initiation input. For example, the object transferring mode initiation input may be any inputs for selecting at least one of objects or entire objects in one of first and second application windows. Such input may include a single tap input, a double tap input, a long press input, a tap and drag input, a drag and drop input, and a copy and paste input. When the received input is not the object transferring mode initiation input (No—S6080), an operation associated with the received input may be performed at step S6090.

When the received input is the object transferring mode initiation input (Yes—S6080), a target object may be determined at step S6100. For example, objects selected by the object transferring mode initiation input may be determined as the target object to be transferred. Particularly, any input made on objects to select the objects may be the object transferring mode initiation input.

At step S6110, determination may be made whether a destination application window is predetermined or not. For example, the destination application window may be determined by a user in advance or related applications. Particularly, when an object in the first application window is selected, the second application window may be automatically selected as the destination application window. Furthermore, when an object in the second application window is selected, the first application window may be automatically selected as the destination application window.

When the destination application window is predetermined (Yes—S6110), the target object may be transferred to the destination application window at step S6120. For example, i) the target object may be replicated, ii) the replica of the target object may be transferred to an application associated with the destination application window, iii) the application may display the replica within the destination application window, and iv) mobile terminal 100 may enable the application to process the replica through the destination application window in response to inputs from a user.

When the destination application window is not predetermined (No—S6110), the destination application window may be determined based on a following input that a user makes at step S6130. The destination application window may be determined by an input followed by the object transferring mode initiation input or the input for selecting the target object. For example, the input may be a single tap input made on one of the first and second application windows, a double tap input made on one of the first and second application windows, a long press input made on one of the first and second application window, a tap and drag input made on an object and dragging to one of the first and second application windows, and a drag and drop input made on an object and dragging to and dropping at one of the first and second windows.

After determining the destination application window, the target object may be transferred to the destination application window at step S6120. For example, i) the target object may be replicated, ii) the replica of the target object may be transferred to an application associated with the determined destination application window, iii) the application may display the replica within the determined destination application window, and iv) mobile terminal 100 may enable the application to process the replica through the determined destination application window in response to inputs from a user. As described above, the process of the object transferring mode may be displayed with various visual effects in order to help a user to easily and conveniently recognize that inputs are being processed. Such visual effects may be popping-up a selected object, highlighting a selected object, expanding a block associated with inputs, overlapping an active application window over an inactive application window, displaying an active application window with higher brightness than an inactive application window, and displaying an inactive application window with lower brightness than an active application window. Such visual effects may be applied to the object transferring mode in various manners in exemplary embodiments of the present invention. Hereinafter, various examples of the object transferring mode performed in accordance with an embodiment of the present invention will be described with reference to FIG. 7 to FIG. 9. The object transferring mode associated with a clipboard will be described with reference to FIG. 7.

FIG. 7 shows a mobile terminal performing an object transferring mode using a clipboard based on a drag and drop input in accordance with an embodiment of the present invention.

Referring to FIG. 7, mobile terminal 100 may display first application window 200 in a right half display area and second application window 300 in a left half display area in a multi_screen mode. A user may make a long press input on an object displayed with second application window 300 as shown in a diagram (A) of FIG. 7. In response to the long press input on the object, mobile terminal 110 may determine that an object transferring mode is initiated and the object is selected as a target object to be transferred. That is, the long press input may initiate the object transferring mode and select the target object. The selected object may be highlighted or popped up in order to visually show a user that an object is selected in response to the input, but the present invention is not limited thereto.

The user may make a drag input for dragging the selected object to a certain portion of first application window 200 as shown in a diagram (B) of FIG. 7. For example, the certain portion may be menu bar 40 of first application window 200. Such menu bar 40 may be referred to as an action bar, but the present invention is not limited thereto. Mobile terminal 100 may determine a destination application window based on the drag input. That is, mobile terminal 100 may determine the first application window as the destination application window because the drag input stops at menu bar 40 of first application window 200. Furthermore, mobile terminal 100 may create a clipboard and display the clipboard within first application window 200. Although it is not visually shown to the user, mobile terminal 100 may replicate the selected object and temporally store the replica in the clipboard.

When the user holds the dragged object in the displayed clipboard for a given time, mobile terminal 100 may expand displayed clipboard 41 corresponding to the dragged object as shown in a diagram (C) of FIG. 7.

When the user drops the dragged object in the clipboard as shown in a diagram (D) of FIG. 7, mobile terminal 100 may transfer the object stored in clipboard 41 to first application window 200. For example, mobile terminal 100 may transfer the replica temporally stored in the clipboard to a first application associated with first application window 200.

After transferring, mobile terminal 100 may resize the clipboard to an original size and display the object within first application window 200 as shown in a diagram (E). That is, mobile terminal 100 may control the first application to display the object within first application window and enable the first application associated with first application window 200 to process in response to an input from a user.

As shown, the first application window is a destination application window and the second application window is a source application window. The clipboard may be used as a virtual storage space and illustrated as being displayed on menu bar 40 of first application window 200 as shown in the diagram (C) of FIG. 7, but the present invention is not limited thereto. The object may be transferred directly to a destination application window and the clipboard may be displayed any portion of first application window 200.

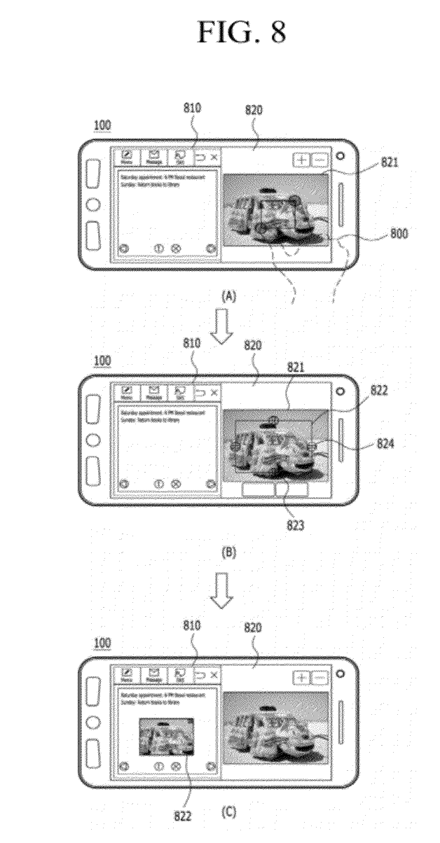

As shown in FIG. 7, a selected object may be transferred from one application window to the other as it is in accordance with an exemplary embodiment of the present invention. The present invention, however, is not limited thereto. Unlike the object transferring mode of FIG. 7, an object may be edited or cropped after selecting the object. Accordingly, the edited object and/or a cropped part of the selected object may be transferred from one application window to the other in accordance with another exemplary embodiment of the present invention. Such object transferring operation will be described with reference to FIG. 8.

FIG. 8 shows a mobile terminal performing an object transferring mode in accordance with another exemplary embodiment of the present invention.

Referring to FIG. 8, two application windows may be simultaneously displayed on display unit 110 of mobile terminal 100. First application window 810 may be a social network service (SNS) application window and second application window 820 may an image editing application window. The SNS application window may enable a user to post a message or an image on a social networking site. The image editing application window may enable a user to edit an image and a picture.

As shown in a diagram (A) of FIG. 8, a user may make two finger tap input 800 on image 821 image editing application window 820. In this case, mobile terminal 100 may determine two finger tap input 800 as an object transferring mode initiation input and select the image 821 as a target object. When the user continuously holds two finger tap 800 on image editing application window 820 for a certain time after the object transferring mode is initiated, mobile terminal 100 may invoke a crop feature of image editing application window 820.

As shown in a diagram (B) of FIG. 8, crop feature interface 822 may be displayed on image 821. The user may control a size of a cropped part of image 821 through crop feature interface 822. For example, crop feature interface 822 may include at least two size control keys 823 and 824. Using at least two size control keys 823 and 824, the user may control a size of a cropped part of image 821. Although not shown in FIG. 8, other image editing tools may be provided in order to allow the user to edit the image.

After controlling the size of a cropped part of image 821 finishes, the user may confirm the completion of editing image 821. Such confirmation may be made through various inputs including releasing two fingers from image 821 or making a single tap input on cropped image 822.

As shown in a diagram (C) of FIG. 8, mobile terminal 100 may transfer cropped image 822 to SNS application window 810. For example, mobile terminal 100 may automatically transfer cropped image 822 to SNS application window 810 upon the completion of editing image 821 when a destination application window is predetermined as SNS application window 810. Alternatively, mobile terminal 100 may determine the destination application window and transfer cropped image 822 to second application window 810 based on an input from the user, followed by the long two finger tap input. The input may be a drag and drop input. After transferring cropped image 822 in SNS application window 810, mobile terminal 100 may enable the user to process cropped image 822 through SNS application window 810. As described above, a selected object may be directly transferred to a destination application window without temporally storing in a clipboard. Furthermore, although a clipboard is not displayed, the selected object may be temporally stored in a clipboard.

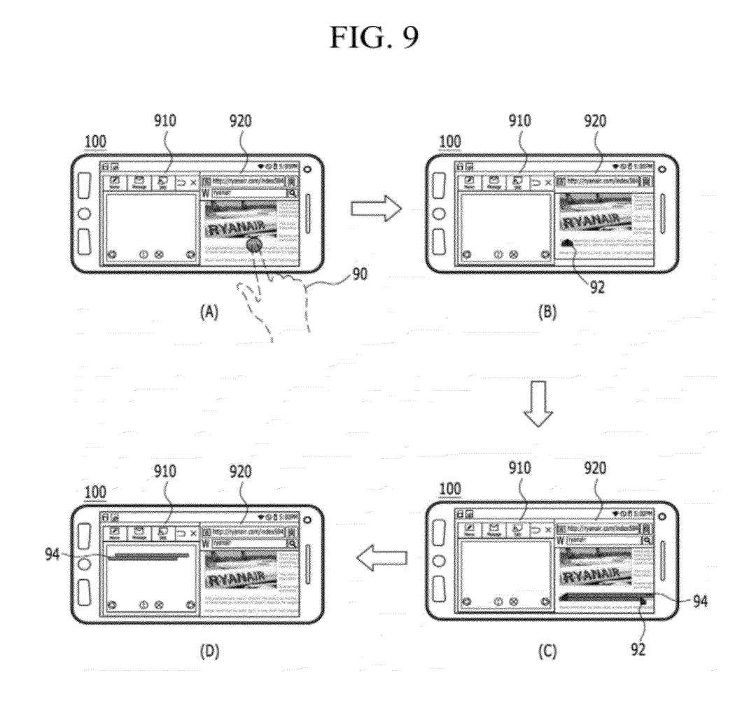

FIG. 9 shows a mobile terminal performing an object transferring operation in accordance another embodiment of the present invention.

Referring to FIG. 9, mobile terminal 100 may transfer texts from a source application window to a destination application window. For example, a web-browser application window may be displayed in main display area 920 and a memo application window may be displayed in multitasking display area 910.

As shown in a diagram (A) of FIG. 9, a search result including an image and texts may be displayed in main display area 920. A user may make long press input 90 on main display area 920.

As shown in a diagram (B) of FIG. 9, selection tool 92 may be displayed on main display area 920. Selection tool 92 may enable the user to select texts or images displayed in main display area 920.

As shown in a diagram (C) of FIG. 9, the user may select texts 94 by moving selection tool 92. For example, a user may make a tap and drag input for moving selection tool 92 to select texts. Mobile terminal 100 may determine that selected texts 94 as a target object to be transferred.

As shown in a diagram (D) of FIG. 9, mobile terminal 100 may transfer selected text 94 to the memo application window displayed in multitasking display area 910. For example, mobile terminal 100 may automatically transfer selected text 94 to the memo application window upon the completion of selecting texts when a destination application window is predetermined as an application window displayed in multitasking display area 910. Alternatively, mobile terminal 100 may determine the destination application window and transfer selected text 94 to the memo application window based on an input from the user, followed by the completion of selecting texts. The input may be a drag and drop input. After transferring text 94 in the memo application window, mobile terminal 100 may enable the user to process selected text 94 through memo application window 910.

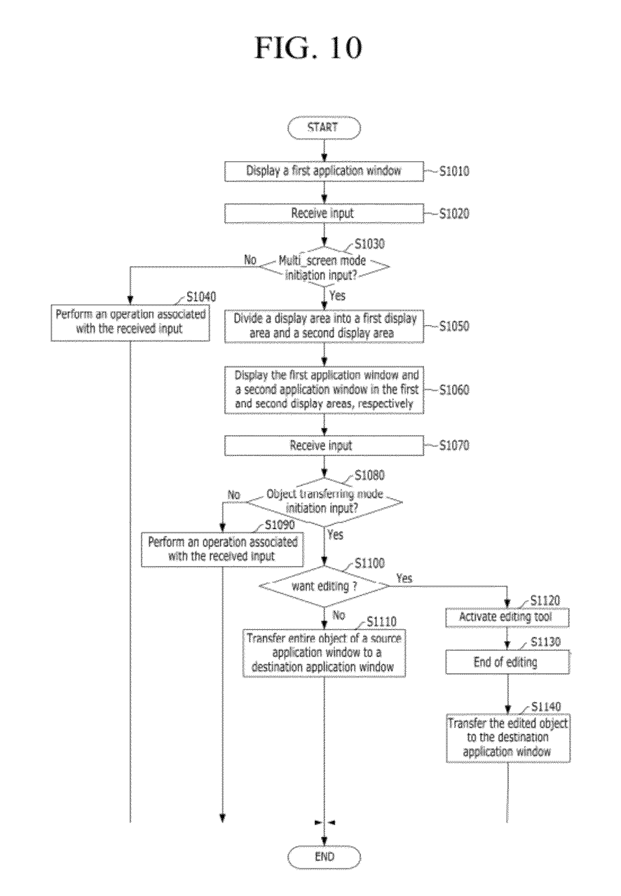

As described above, a selected object may be transferred from a source application window to a destination application window in accordance with an exemplary embodiment of the present invention. Furthermore, the selected object may be edited or cropped and the edited object or the cropped part of the object may be transferred from a source application window to a destination application window in accordance with another exemplary embodiment of the present invention. Hereinafter, the object transferring mode with editing objects will be described with reference to FIG. 10.

FIG. 10 shows a method for transferring objects from a source application window to a destination application window in accordance with another exemplary embodiment of the present invention.

Referring to FIG. 10, when a user activates an application in a mobile terminal, a first application window associated with the activated application may be displayed on an entire display area of mobile terminal at step S1010. For example, mobile terminal 100 may display initial graphic user interface 500 when mobile terminal 100 is initiated. A user may activate icon 601 in initial graphic user interface 500 and mobile terminal 100 may display first application window 200 associated with icon 601 on entire display area 410. That is, mobile terminal 100 may display first application window 200 in a single_screen mode.

While displaying the first application window, an input may be received from a user at step S1020. For example, a related user may enter various types of inputs into mobile terminal 100 though at least one of graphic user interface 500, key buttons 180, and a key pad of mobile terminal 100 in order to perform a desired feature. Particularly, the related user may enter an input to display second application window 300 associated with an application running as a background mode. In this case, the user may activate a multi_screen mode in order to display second application window 300 with first application window 200 at the same time on display unit 110 of mobile terminal 100. When the user wants to initiate the multi_screen mode, the user may enter a multi_screen mode initiation input. The multi_screen mode initiation input may be one of menu buttons 11 and 12 displayed as a part of application window as shown in FIG. 3. The multi_screen mode initiation input may be one of icons included in initial graphic user interface 500 displayed on display unit 110 of mobile terminal 100. Furthermore, the multi_screen mode initiation input may be one of keys in a keypad and key buttons, which is set up as the multi_screen mode initiation input by the user or a system designer. Particularly, the multi_screen mode initiation input may be a gesture input such as a pinch input and a spread input. As described above, various types of inputs may be received from the user.

At step S1030, determination may be made whether the received input is for initiating a multi_screen mode. As described above, when mobile terminal 110 receives an input, mobile terminal 110 may determine whether the received input is a multi_screen mode initiation input or not.

When the received input is not the multi_screen mode initiation input (No—S1030), an operation associated with the received input may be performed at step S1040, and the process ends.

When the received input is the multi_screen mode initiation input (Yes—S1030), a display area may be divided into a first display area and a second display area at step S1050. For example, when mobile terminal 100 receives an input from menu button 11 in bottom menu bar 102, menu button 12 in top menu bar 104, key button 13 provided on mobile terminal 100, or gesture input such as a pinch input or a spread input, mobile terminal 100 may determine that the received input is the multi_screen mode initiation input. When mobile terminal 100 determines that the received input is the multi_screen mode initiation input, mobile terminal 100 may divide display area 410 into first display area 210 and second display area 310. The present invention, however, is not limited thereto. The display area may be divided into more than two display areas in accordance with another embodiment of the present invention. For convenience and ease of understanding, the display area will be described as being divided into two display areas, such as the first display area and the second display area.

At step S1060, the first application window may be displayed in the first display area and a second window may be displayed in the second display area. For example, mobile terminal 100 may reconfigure first application window 200, which was previously displayed on entire display area 410 of display unit 110, and display reconfigured first application window 200 in first display area 210. Since the entire display area is divided into two display areas, first application window 200 may be shrunk to be fit into first display area 210. Furthermore, mobile terminal 100 may activate a second application previously selected by one of a user and a manufacturer of mobile terminal 100. Mobile terminal 100 may display second application window 300 in second display area 310. Second application window 300 may be associated with the activated second application. The second application may be a multitasking application previously selected by a manufacturer of mobile terminal 100. The multitasking application may enable a user to choose and to perform one from a set of selected applications. Furthermore, the second application may be one of applications running in a background mode. Such background mode applications may be indicated on menu bars 102 and 104. A user may select and activate one of background applications indicated on menu bars 102 and 104. In response to the selection and activation, second application window 300 associated with the selected background application may be displayed on second display area 310. In addition second application window 300 displayed on second display area 310 may be changed by selecting another background application indicated in menu bars 102 and 104. For example, when a user may select one of applications indicated by menu bars 102 and 104 while second application window 300 is displayed on second display area 310, second application window 300 may be closed and an application window associated with the selected application may be displayed on second display area 310 as new second application window 300. The present invention, however, is not limited thereto. The second application may be any application selected by a user or by mobile terminal 100 and a corresponding application window may be displayed on second display area 310. Instead of the applications, initial graphic user interface 500 may be displayed in the second display area as second application window 300.

At step S1070, an input may be received after the first and second application windows are displayed in the multi_screen mode. For example, various types of inputs may be received while first and second application windows 200 and 300 are displayed in the multi_screen mode. Such inputs may be for activating features included in first and second application windows.

At step S1080, determination may be made whether the received input is an object transferring mode initiation input. For example, the object transferring mode initiation input may be any inputs for selecting at least one of a portion of an object or entire objects in one of first and second application windows. Such input may include a single tap input, a double tap input, a long press input, a tap and drag input, a drag and drop input, and a copy and paste input. Furthermore, based on the received input, a target object to be transferred may be determined too.

When the received input is not the object transferring mode initiation input (No—S1080), an operation associated with the received input may be performed at step S1090, and the process ends.

When the received input is the object transferring mode initiation input (Yes—S1080), determination may be made as to whether editing of a target object is initiated at step S1100. For example, editing of the target object may be initiated by inputs made on the target object. Or, the object transferring mode initiation input may indicate initiating the editing of the target object. Particularly, a two finger long press input may initiate the editing of the target object as well as initiating the object transferring mode, but the present invention is not limited thereto. Other types of inputs may be set up as an input for initiating the editing of the target object.

If the editing of the target object is not initiated (No—S1100), an entire target object may be transferred to a destination application window as it is at step S1110. For example, when a user simply drag the target object to a menu bar of a destination application window, mobile terminal 100 may determine that the user does not want to edit the target object or that the user wants to transfer the entire object as it is. Accordingly, mobile terminal 100 may transfer the entire target object to the destination application window as it is. Such an operation may be shown in FIG. 7.

When the editing of the target object is initiated (Yes—S1100), a related editing tool may be activated and displayed associated with the target object at step S1120. For example, when user may make two finger tap input 800 on image 821 image editing application window 820 as shown in FIG. 8, mobile terminal 100 may determine two finger tap input 800 as an object transferring mode initiation input and select the image 821 as a target object. When the user continuously holds two finger tap 800 on image editing application window 820 for a certain time after the object transferring mode is initiated, mobile terminal 100 may invoke a crop feature of image editing application window 820.

After providing the editing tool, by monitoring the activity, a determination may be made as to when the user completes editing the target object at step S1130. For example, such determination may be made through various inputs. Particularly, when two fingers are released from image 821 or when a single tap input is made on cropped image 822, mobile terminal 100 may determine that the editing is completed.

When the editing is completed at step S1130, the edited target object may be transferred to the destination application window at step S1140. For example, mobile terminal 100 may automatically transfer the edited target object to the destination application window upon the completion of editing when a destination application window is predetermined. Alternatively, mobile terminal 100 may determine the destination application window and transfer the edited target object to the destination application window based on an input from the user. The input may be a drag and drop input. After transferring the edited target object to the destination application window, mobile terminal 100 may enable the user to process the edited target object through the destination application window.

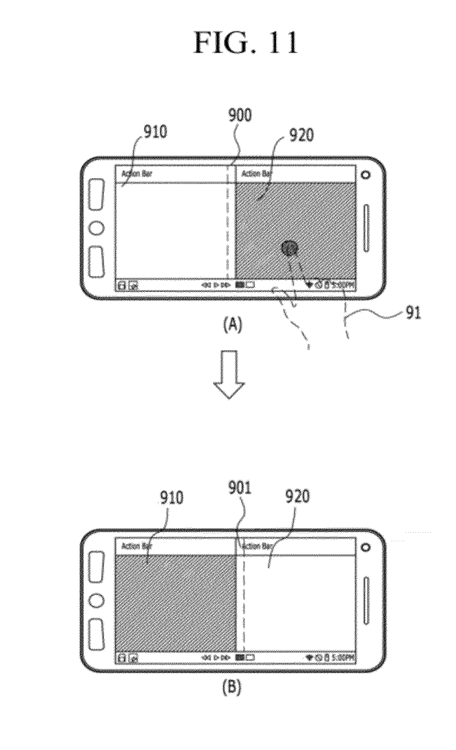

As described above, the application windows are displayed with various visual effects in order to help a user to easily and conveniently recognize a process of an object transferring mode in accordance with an exemplary embodiment of the present invention. One of visual effects may be displaying one application window to be overlapped on the other. For example, when a user activate a first application window while the first application window and a second application window are displayed simultaneously displayed on a display unit of a mobile terminal, the mobile terminal may display at least one part of the first application window to be overlapped over corresponding part of the second application window. Such an operation may be applied to the object transferring modes described above. Hereinafter, such an operation will be described with reference to FIG. 11

FIG. 11 shows a mobile terminal for displaying one application window to be overlapped over the other in accordance with an exemplary embodiment of the present invention.

Referring to FIG. 11, a first application window and a second application window may be simultaneously displayed on a display unit of a mobile terminal. In this case, mobile terminal may display activated one to be overlapped over the other. For example, first application window 910 may be displayed on a left half display area and second application window 920 may be displayed on a right half display area.

As shown in a diagram (A) of FIG. 11, when a user make an input 91 on second application window 920, second application window 920 is activated. In this case, first application window 910 may be inactivated. Activating an application window may means that a user is enabled to control the activated application window. The mobile terminal may display certain part 900 of activated second application window 920 to be overlapped over a corresponding part of inactivated first application window 910. For example, certain part 900 may be a part at boundary between first application window 910 and second application window 920. As activating second application window 920, a user may control objects in second application window 920.

As shown in a diagram (B) of FIG. 11, when a user make an input on first application window 910, first application window 910 is activated and second application window 920 is inactivated. Accordingly, the mobile terminal may display a certain part 901 of first application window 910 to be overlapped over a corresponding part of second application window 920. As activating first application window 910, a user may control objects in first application window 910.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for transferring objects from a first application window to a second application window displayed on a display unit of a mobile terminal, the method comprising:
displaying the first application window and the second application window simultaneously on the display unit in response to a multi_screen mode initiation input; and
transferring at least one of a portion of and an entire object in one of the first application window and the second application window to another application window in response to an object transferring mode initiation input.

2. The method of claim 1, wherein the transferring at least one of a portion of and an entire object includes:
receiving an input from a user;
determining whether the received input is the object transferring mode initiation input;
performing an object transferring mode in response to the object transferring mode initiation input;
otherwise, performing an operation associated with the received input.

3. The method of claim 2, comprising determining that the received input is the object transferring mode initiation input when the received input is an input for selecting the at least one of the portion of and the entire object included in one of the first application window and the second application window.

4. The method of claim 3, wherein the input for selecting the at least one of the portion of and the entire object is at least one of a single tap input, a double tap input, a long press input, a tap and drag input, a drag and drop input, and a copy and paste input, which are made on the object included in the one of the first application window and the second application window.

5. The method of claim 2, wherein the performing an object transferring mode includes:
determining a target object for transfer;
determining a destination application window; and
transferring the determined target object to the determined destination application window.

6. The method of claim 5, comprising identifying the at least one of the portion of and the entire object selected by the object transferring mode initiation input as the target object and the one of the first application window and the second application window that includes the target object as the source application window.

7. The method of claim 5, wherein the destination application window is previously defined by at least one of a user, an application associated with the source application window, and an operating system of the mobile terminal.

8. The method of claim 7, wherein when the object transferring mode initiation input is a copy and paste input, including:
determining the target object associated with the copy and paste input; and
determining the previously defined application window as the destination application window.

9. The method of claim 5, wherein the determining a destination application window includes:
receiving an input after the determining a target object; and
determining the destination application window based on the received input.

10. The method of claim 9, wherein the received input is at least one of a single tap input, a double tap input, and a long press input, which are made on the destination application window, and a drag and drop input for dragging the selected object to the destination application window and dropping the selected object at the destination application window.

11. The method of claim 5, wherein after the determining a target object, the performing an object transferring mode includes:
determining user editing of the determined target object;
providing an editing tool associated with the target object for determined user editing; and
updating the edited target object as the target object for transfer.

12. The method of claim 5, wherein the transferring the at least one of the portion of and the entire object includes:
replicating the target object;
displaying the replicated target object within the destination application window; and
processing the replicated target object through the destination application window in response to input associated with the replicated target object.

13. The method of claim 12, wherein the transferring the at least one of the portion of and the entire object includes:
storing the replicated target object in a clipboard.

14. The method of claim 1, wherein the displaying the first application window and the second application window simultaneously on the display unit in response to a multi_screen mode initiation input includes:
displaying the first application window on an entire display area of the display unit;
receiving the multi_screen mode initiation input from a user;
dividing a display area of the display unit into at least two display areas including a first display area and a second display area in response to the multi_screen mode initiation input; and
displaying the first application window and the second application window on the first display area and the second display area, respectively.

15. The method of claim 14, wherein the receiving a multi_screen mode initiation input includes:
receiving an input from the user;
determining whether the received input is at least one of a predetermined key button designated to initiate a multi_screen mode, a predetermined icon designated to initiate the multi_screen mode, a pinch input made by an associated pinching motion exceeding a shrinking threshold, and a spread input made by an associated spreading motion exceeding an expanding threshold;
initiating the multi_screen mode when the received input is made through the at least one of the predetermined key button, the predetermined icon, the pinch input, and the spread input; and
otherwise, performing an operation associated with the received input.

16. A mobile terminal comprising:
a display unit configured to sense a touch input made on a surface thereof, to determine coordinate values of the sensed touch input at a given interval, to display an application window on an entire display area in a single_screen mode, to display at least two application windows separately on divided display areas in a multi_screen mode, and to display objects being transferred from one application window to the other in an object transferring mode;
a touch input processor configured to receive the coordinate value from the display unit and to determine whether the sensed touch input is at least one of a multi_screen mode initiation input, a single_screen mode initiation input, and an object transferring mode initiation input based on the received coordinate values of the touch input; and
a controller configured to initiate at least one of a multi_screen mode, a single_screen mode, and an object transferring mode based on the determination result of the touch input processor.

17. The mobile terminal of claim 16, wherein the touch input processor is configured to:
determine, based on the received coordinate value, whether the sensed touch input is at least one of a single tap input, a double tap input, a long press input, a tap and drag input, a drag and drop input, and a copy and paste input, which initiate the object transferring mode;
when the sensed touch input is the at least one of a single tap input, a double tap input, a long press input, a tap and drag input, a drag and drop input, and a copy and paste input, communicate to the controller of the initiation of the object transferring mode.

18. The mobile terminal of claim 16, wherein the touch input processor is configured to:
determine whether the sensed touch input is at least one of a predetermined icon, a closing request, a pinch input, and a spread input based on the received coordinate values of the sensed touch input;
when the sensed touch input is the predetermined icon, determine that the sensed touch input is at least one of the multi_screen mode initiation input and the single_screen mode initiation input when the predetermined icon is associated with initiation of one of the multi_screen mode initiation input and the single_screen mode initiation input;
when the sensed touch input is the closing request, determine that the sensed touch input is the single_screen mode initiation input;
when the sensed touch input is the pinch input, determine that the pinch input is at least one of the multi_screen mode initiation input and the single_screen mode initiation input when pinching motion of the pinch input exceeds a range of shrinking an application window; and
when the sensed touch input is the spread input, determine that the spread input is at least one of the multi_screen mode initiation input and the single_screen mode initiation input when spreading motion of the spread input exceeds a range of expanding an application window.

19. The mobile terminal of claim 17, wherein the controller is configured to:
when the touch input processor communicates the initiation of the object transferring mode,
determine a target object based on the sensed touch input;
determine a destination application window based on the sensed touch input;
replicate the target object;
control the display unit to display the replicated target object within the destination application window; and
enable an application associated with the destination application window in response to input from a user.

20. The mobile terminal of claim 18, wherein when the touch input is the multi_screen mode initiation input based on the determination result of the touch input processor, the controller is configured to:
divide a display area of the display unit into at least two display areas including a first display area and a second display area;
activate a second application previously defined by one of a user and a manufacturer of the mobile terminal;
reconfigure a first application window corresponding to the first display area, display the reconfigured first application window on the first display area; and
display a second application window associated with the second application on the second display area, wherein the first application window is an application window previously displayed on an entire display area of the display unit, and
when the touch input is the single_screen mode initiation input based on the determination result of the touch input processor, close one, associated with the single_screen mode initiation input, of the first application window and the second application window, and display the other one of the first application window and the second application window on the entire display area of the display unit.
